(19) United States
(12) Patent Application Publication
(10) Pub. No.: US 2011/0071256 A1
(43) Pub. Date: Mar. 24, 2011

(54) COATING COMPOSITION

(75) Inventors: Ruediger Nowak, Kandern-Egerten (DE); Thomas Schlosser, Inzlingen (DE); Reiner Wartusch, Burstadt (DE)

(73) Assignee: EVONIK DEGUSSA GmbH, Essen (DE)

(21) Appl. No.: 12/988,379

(22) PCT Filed: Apr. 14, 2009
(86) PCT No.: PCT/EP09/54403

§ 371 Date: Oct. 18, 2010

(30) Foreign Application Priority Data
May 15, 2008 (DE) 10 2008 001 808.2

(51) Int. Cl. C09D 163/00

(52) U.S. Cl. 524/611

(57) ABSTRACT

The invention relates to coating compositions comprising A) 5.0% to 50.0% by weight of epoxy resins which constitute reaction products of bisphenol A and/or bisphenol F with epichlorohydrin, B) 5.0% to 55.0% by weight of water-dilutable epoxy resin hardeners, C) 0.1% to 10.0% by weight of fibres, D) 0% or 0.1% to 5.0% by weight of wax-based open-time extenders, E) 0% or 0.1% to 5.0% by weight of rheology additives, F) 5.0% to 70% by weight of fillers, G) 0% or 0.1% to 20.0% by weight of water and H) 0% to 70% by weight of further additives and/or processing assistants, the sum of the percentages by weight of components A) to H) making 100% by weight, and the rheology additive (component E) or the filler (component F) being replaced by a fumed silica which has been hydrophobicized with HMDS (hexamethyldisilazane) and subsequently structurally modified by means of a ball mill.

The invention relates to coating compositions.

The use of solvent-borne and solvent-free, thermoset 2-component epoxy systems for liquid casting resin applications, floor-levelling compositions and concrete preservation systems is known from the technical literature (for example: E. Foglianisi, R. Grützmacher, R. Höfer: Wofür eignen sich Fussbodenbeschichtungen aus Polyurethanund Epoxy-Harzen? [What are suitable applications for floor coatings made from polyurethane resins and epoxy resins?] Industriebau, Suppl. Industrie-Boden-Technik 43, [2], March/April 1997, pages 18-20); aqueous systems are also already mentioned therein.

Aqueous epoxy systems have been known for cathodic electrodeposition coating in the automotive industry, but also for can coatings and anti-corrosion primers, for a relatively long time (for example: J. L. Chou, Novel Corrosion-Resistant Waterborne Epoxy Coatings, Polymers Paint Colour Journal, 1994 (Vol. 184), pages 413 and 416-417).

To prepare epoxy resin emulsions it is possible in principle to choose the same surface-active compounds which are already established for the preparation of thermoplastic polymer dispersions by the emulsion polymerization process and which for example are described in C. Baumann, D. Feustel, U. Held, R. Höfer, Stabilisierungssysteme für die Herstellung von Polymer-Dispersionen [Stabilizing systems for the preparation of polymer dispersions], Welt der Farben, 2/1996, pages 15-21.

Despite the fact that, as set out above, the person skilled in the art was aware of both solvent-borne and aqueous epoxy resins, and that such resins had already been used for some time in the construction sector for paints and coatings purposes, there were nevertheless still inadequacies found in relation to their use as insulating and levelling compounds, these inadequacies being that the necessary combination of properties such as good processing, alkali resistance, water resistance, early water resistance, sufficient open time and at the same time ease of recognizing when the end of processability has been reached, self-levelling properties, high compressive strength, storage stability and sedimentation stability in conjunction with high filler binding capacity and environmental and toxicological unobjectionability is not achieved.

It was an object of the present invention to provide insulating and levelling compounds which are distinguished by improved performance properties as compared with systems known from the prior art.

By levelling and insulating compounds are meant in the context of the present invention more particularly floor-coating compounds based on epoxy resins that, when applied to concrete, wood or other substrates, level out rapidly and readily and produce an even surface. They may contribute to soundproofing and heat retention in the sense of German state construction regulations (e.g. “Die neue Bauordnung für Hessen”, published by Hessischer Städte- and Gemeindebund, Kommunale Schriften für Hessen 45, quoted by H. Klopfer, Muss man Industriefussböden warmedammen? [Do industrial floors require thermal insulation?] in Industriefussböden '95, Techn. Akademie Esslingen, Ostfildern, 1995). From this definition it is evident that levelling and insulating compounds are to be included among coating compositions.

The present invention provides coating compositions comprising
A) 5.0% to 50.0% by weight of epoxy resins which constitute reaction products of bisphenol A and/or bisphenol F with epichlorohydrin,
B) 5.0% to 55.0% by weight of water-dilutable epoxy resin hardeners,
C) 0.1% to 10.0% by weight of fibres,
D) 0% or 0.1% to 5.0% by weight of wax-based open-time extenders,
E) 0% or 0.1% to 5.0% by weight of rheology additives,
F) 5.0% to 70.0% by weight of fillers,
G) 0% or 0.1% to 20.0% by weight of water and
H) 0% to 70% by weight of further additives and/or processing assistants,
   the sum of the percentages by weight of components A) to H) making 100% by weight, and the rheology additive (component E) or the filler (component F) being replaced by a fumed silica which has been hydrophobicized by means of hexamethyldisilazane (HMDS) and subsequently structurally modified by means of a ball mill.

This silica is known from DE 196 16 781 A1.

With preference it is possible to use the fumed, HMDS-hydrophobicized and ball mill-structurally modified silica AEROSIL R 8200.

The physiochemical parameters of this silica are as follows:

| | | Guide |
|---|---|---|
| Properties | Unit | values |
| Specific surface area (BET) | m²/g | 160 ± 25 |
| C content | % by weight | 2.0 − 4.0 |
| Tapped density* | g/l | about 140 |
| (approximate value) based on | | |
| DIN EN ISO 787/11, August 1983 | | |
| Loss on drying* | % by weight | <0.5 |
| 2 h at 105° C. | | |
| pH value | | >5.0 |
| 4% dispersion | | |
| SiO₂ content | % by weight | >99.8 |
| based on calcined substance | | |

*ex works

It is expressly noted that as far as components A) to F) are concerned, individual types or mixtures of such types can be used in each case. Hence it is possible in each case for either one or two or more epoxy resins A), epoxy resin hardeners B), fibres C), open-time extenders D), rheology additives E) and/or fillers F) to be employed.

The coating compositions can be prepared in any way that is known to the person skilled in the art. More particularly the components can be mixed with one another in succession. It is also possible, however, for two or more components to be pre-processed first of all and to be brought in that form into contact with further components, the completed coating composition then resulting therefrom. This last-mentioned variant applies in particular to component G) (i.e. water); water—where water is employed—can be introduced into the system as a whole in a variety of different ways in the course of the preparation of the coating compositions of the invention; for example, it is possible particularly for commercially available compounds of classes A) to F) to be used in their aqueous supply form. Water, in other words, may on the one hand be introduced per se together with the other components of the coating composition that are used mandatorily, or, alternatively, water may also be introduced by using individual or all of components A) to F) in an aqueous supply form; a combination of both ways is also possible.

In one preferred embodiment the procedure adopted for preparing the coating compositions is as follows: first of all, all of components B) to H) are mixed to form a mixture (I), and then component A) is added to this mixture (I). The ratio of the mixture (I) and the component A) in this case is preferably selected such that the hardener B) present in (I), and the component A), are present in an equimolar ratio in the resulting coating composition.

The percentages by weight given for components A) to H) refer, incidentally, always to the respective active substance content. If, for example, a coating composition is prepared by using one or more components in an aqueous supply form, then, with a view to the characterization of the make-up of the overall coating composition, the critical factor for the individual components is the amount of active substance present in each case, and not whether the coating composition has been prepared using certain components in hydrous or anhydrous form; the fraction of component G), i.e. water, is obtained, accordingly, in each case as the sum of the water that is present in the coating composition as a whole.

### Component A)

Component A) of the coating compositions of the invention comprises epoxy resins which constitute reaction products of bisphenol A and/or bisphenol F with epichlorohydrin. Such reaction products are known to the person skilled in the art. In this context reference may be made, for example, to the publication by Julia Möckel and Udo Fuhrmann, Epoxidharze—Schlüsselwerkstoffe für die moderne Technik [Epoxy resins—key materials for modern technology], Die Bibliothek der Technik, Volume 51, Verlag moderne Industrie, 1990, pages 4-7. There it is mentioned in particular that the most common epoxy resins are condensation products of bisphenol A and epichlorohydrin, with the length of the molecular chains formed in this reaction being dependent on the molar ratio of the starting components employed, and being described by the index n. As the chain length goes up, there is an increase in the molecular weight and, at the same time, in the viscosity of the compounds. Unmodified resins of this type have a liquid consistency at 20 deg C. (room temperature) for 0>n>1, while in the case of the corresponding solid resins n is 2-13 or more. The corresponding bisphenol F resins are also specified in that publication.

The liquid unmodified bis-A and bis-F epoxy resins are solvent-free, readily processible, and possessed typically of viscosities in the range from 5000 to 15 000 mPa·s, preferably 5000 to 10 000 mPa·s (the viscosities quoted refer here and below to measurements without solvent at 20 deg C., measured using a Brookfield viscometer). They are available commercially, for example, under the name Chem-Res E 30 (Henkel S.p.A, Milan, I).

If desired it is possible to achieve a further reduction in the viscosity of such resins by addition of reactive diluents, to 200 mPa·s, for example. Reactively diluted resins are also available commercially, as for example under the name Chem-Res E 97 (Henkel S.p.A, Milan I). For the purposes of the present invention, such reactively diluted resins would be mixtures of components A) and E), since reactive diluents are included among the rheology additives.

In one embodiment use is made as component A) of epoxy resins of the abovementioned type (reaction products of bisphenol A and/or bisphenol F with epichlorohydrin) that are liquid at 20 deg C.

As component A) it is preferred to use reaction products of bisphenol A with epichlorohydrin that are liquid at 20 deg C.

In one embodiment, component A) is used in an amount of 5% to 30% by weight.

### Component B)

Component B) of the coating compositions of the invention comprises water-dilutable epoxy resin hardeners. As component B) it is preferred to use compounds which derive from adducts based on α,β-unsaturated carboxylic esters and mono-, di- or polyaminopolyalkylene oxide compounds. The compounds B) are preferably selected from the group of types B1) to B3) described in more detail below.

Hardeners of type B1) are obtainable by subjecting

a) one or more α,β-unsaturated carboxylic esters (I)

R²R³C═C(R⁴)COOR¹ (I)

in which the radical R¹ is an aromatic or aliphatic radical having up to 15 carbon atoms, the radicals R², R³ and R⁴ independently of one another are hydrogen, branched or unbranched, aliphatic or aromatic groups having in each case up to 20 carbon atoms, or a group —(CH₂)ₙ—COOR¹ in which R¹ is as defined above and n is a number in the range from 0 to 10, to reaction in the presence of a trans-esterification catalyst with
b) one or more hydroxy compounds,
compounds (a) and (b) being used in amounts such that the equivalents ratio of the hydroxyl groups in (b) to the esters groups COOR¹ in the α,β-unsaturated carboxylic esters (a) is in the range from 1.5:1 to 10:1,
reacting the resultant intermediate Z1 with
c) one or more mono-, di- or polyaminopolyalkylene oxide compounds, an equivalents ratio of the reactive H atoms on the amino nitrogen atom of (c) to the ester groups in the intermediate compound Z1 being adjusted to in the range from 10:1 to 1:10,
subsequently reacting the resulting intermediate Z2 with
d) one or more polyepoxides, the equivalents ratio of oxirane rings in polyepoxide (d) to reactive hydrogen atoms of the mono-, di- or polyaminopolyalkylene oxide compounds used as per (c) being adjusted to a value in the range from 100:1 to 1.5:1,
and subsequently reacting the resulting intermediate Z3 with
e) one or more primary and/or secondary amines, the equivalents ratio of oxirane rings in intermediate Z3 to the reactive H atoms on the amino nitrogen atoms of (e) being adjusted to a value in the range from 1:1.5 to 1:20.

According to their molecular weight, the hardeners of the invention represent either liquid or solid substances.

The expression “equivalents ratio” is familiar to the person skilled in the art. The fundamental concept behind the idea of the equivalent is that, for each substance involved in a reaction, the reactive groups involved in the target reaction are considered. By stating an equivalents ratio, an expression is then given of the numerical ratio between the entirety of the reactive groups of the compounds (x) and (y) that are used. In this context it should be noted that a reactive group is the smallest-possible reactive group—the concept of the reactive group, therefore, is not congruent with the idea of the functional group. In the case of H-acidic compounds, for instance, this means that OH groups or NH groups do constitute such reactive groups, but not NH2 groups, where two reactive H atoms are located on the same nitrogen atom. Here, rationally, the two hydrogen atoms are considered as a reactive group within the functional group NH2, and so the functional group NH2 contains two reactive groups, namely the hydrogen atoms.

In one embodiment the intermediate compound Z1 and the compound (c) are used in amounts such that the equivalents ratio of the reactive H atoms on the amino nitrogen atoms of (c) to the ester groups in the intermediate compound Z1 is in the range from 4:1 to 1:4 and more particularly from 2.5:1 to 1.5:1.

In one embodiment the equivalents ratio of oxirane rings in polyepoxide (d) to reactive hydrogen atoms of the mono-, di- or polyaminopolyalkylene oxide compounds used as per (c) is adjusted to a value in the range from 50:1 to 10:1.

Examples of the α,β-unsaturated carboxylic esters (a) of the abovementioned structure (I) that are intended for use in accordance with the invention are methyl acrylate, ethyl acrylate, dimethyl maleate, diethyl maleate, dimethyl fumarate, diethyl fumarate, dimethyl itaconate and diethyl itaconate. Particular preference as compounds (a) is given to dialkyl maleates, especially diethyl maleate and dimethyl maleate.

The hydroxy compounds (b) may be aliphatic or aromatic. The compounds (b) ought to be inert towards transesterification catalysts.

Examples of suitable aromatic compounds (b) are as follows: resorcinol, hydroquinone, 2,2-bis(4-hydroxyphenyl)propane (bisphenol A), isomer mixtures of dihydroxydiphenylmethane (bisphenol F), tetrabromobisphenol A, 4,4′-dihydroxy-diphenylcyclohexane, 4,4′-dihydroxy-3,3-dimethyldiphenyl-propane, 4,4′-dihydroxybiphenyl, 4,4′-dihydroxybenzophenol, 1,1-bis(4-hydroxyphenyl)ethane, 1,1-bis(4-hydroxy-phenyl)isobutane, bis(4-hydroxyphenyl)methane, bis(4-hydroxyphenyl)ether, bis(4-hydroxyphenyl)sulphone, etc., and also the chlorination and bromination products of the aforementioned compounds. Bisphenol A is preferred as aromatic compound (b).

In one preferred embodiment the hydroxy compounds (b) are selected from the class of the fatty alcohols, alkanediols and polyether diols. If desired these compounds may also be in alkoxylated form.

The fatty alcohols are primary alcohols having 6 to 36 C atoms, and may be saturated or olefinically unsaturated. Examples of suitable fatty alcohols are hexanol, heptanol, octanol, pelargoyl alcohol, decanol, undecanol, lauryl alcohol, tridecanol, myristyl alcohol, pentadecanol, palmityl alcohol, heptadecanol, stearyl alcohol, nonadecanol, arachidyl alcohol, heneicosanol, behenyl alcohol, tricosanol, lignoceryl alcohol, 10-undecanol, oleyl alcohol, elaidyl alcohol, ricinolyl alcohol, linoleyl alcohol, linolenyl alcohol, gadoleyl alcohol, arachidonoyl alcohol, erucyl alcohol and brassidyl alcohol.

The alkanediols are compounds of the general structure HO—CH₂—R⁵—CH₂—0H in which the radical R⁵ is a hydrophobic hydrocarbon radical which may be saturated or unsaturated, straight-chain or branched and if desired may also contain aromatic structural elements. Examples are 1,6-hexanediol, 1,7-heptanediol and 1,8-octanediol, and also polyoxytetra-methylenediols—also known as polytetrahydrofurans—and also the diols known as dimer diols. The dimer diols are especially preferred in the context of the present invention.

Dimer diols are compounds which have been available commercially and known for a long time, and are obtained, for example, by reduction of dimer fatty acid esters. The dimer fatty acids on which these dimer fatty acid esters are based on carboxylic acids which are accessible through oligomerization of unsaturated carboxylic acids, generally fatty acids such as oleic acid, linolic acid, erucic acid and the like. The oligomerization typically takes place at an elevated temperature in the presence of a catalyst comprising alumina, for instance. The resulting substances —technical-grade dimer fatty acids—represent mixtures, with the dimerization products predominating. However, there are also small fractions of higher oligomers present, in particular the trimer fatty acids. Dimer fatty acids are commercial products and are available in various compositions and grades. There is an extensive literature relating to dimer fatty acids. By way of example, the following articles may be cited here: Fette & Öle 26 (1994), pages 47-51; Speciality Chemicals 1984 (Mai-Heft), pages 17, 18, 22-24. Dimer diols are well known in the art. In this regard, reference may be made by way of example to a relatively recent article which deals, among other things, with the preparation, structure and chemistry of the dimer diols: Fat Sci. Technol. 95 (1993) No. 3, pages 91-94. For the purposes of the present invention, preference is given to those dimer diols which have a dimer content of at least 50% and more particularly 75% and in which the number of C atoms per dimer molecule is predominantly in the range from 36 to 44.

Polyether diols for the purposes of the present invention are diols of the general structure HO—CH₂—R⁶—CH₂—0H in which the radical R⁶ is a hydrophobic hydrocarbon radical which may be saturated or unsaturated, straight-chain or branched and may optionally also include aromatic structural elements, and in which necessarily one or more CH₂ units have been replaced each by an oxygen atom.

One particularly attractive class of polyether diols is accessible through alkoxylation of alkanediols such as 1,2-ethanediol, 1,3-propanediol, 1,2-propanediol, 1,4-butanediol, 1,3-butanediol, 1,5-pentanediol, 1,6-hexanediol, 1,7-heptanediol and 1,8-octanediol, polyoxytetramethylenediols (polytetrahydrofurans) and dimer diols. The approach typically taken in preparing these alkoxylated diols is as follows: in a first step, the desired diol is contacted with ethylene oxide and/or propylene oxide and this mixture is reacted in the presence of alkaline catalyst at temperatures in the range from 20 to 200 deg C. In this way, adducts of ethylene oxide (EO) and/or propylene oxide (PO) with the diol employed are obtained. The addition products are therefore EO adducts or PO adducts or EO/PO adducts of the respective diol; in the case of the EO/PO adducts, the addition of EO and PO may take place statistically or blockwise.

Suitable transesterification catalysts for the reaction of the compounds (a) and (b) include per se all of the transesterification catalysts that are known to the person skilled in the art from the state of the art. Examples of suitable catalysts are sodium methoxide, dibutyltin diacetate and tetraisopropyl orthotitanate. After the transesterification, the catalysts can be deactivated if desired, though this is not absolutely necessary.

Serving as amino components (c) are mono-, di- or polyaminopolyalkylene oxide compounds. This means that these compounds have one, two or more amino functions (NH or NH2 functions) and also contain alkylene oxide units. The last-mentioned units are more particularly ethylene oxide, propylene oxide and butylene oxide, with ethylene oxide and propylene oxide being particularly preferred. The compounds (c) are substances which are soluble at least partly in water at 20 deg C.

The preparation of the compounds (c) is known from the prior art and includes the reaction of hydroxyl-containing compounds with alkylene oxides, as well as subsequent conversion of the resulting terminal hydroxyl groups into amino groups.

With regard to the reaction of hydroxyl-containing compounds with alkylene oxides, ethoxylation and propoxylation are particularly important. In this case a typical approach is as follows: in a first step the desired hydroxyl-containing compounds are contacted with ethylene oxide and/or propylene oxide and this mixture is reacted in the presence of an alkaline catalyst at temperatures in the range from 20 to 200 deg C. This produces adducts of ethylene oxide (EO) and/or propylene oxide (PO). The addition products are preferably EO adducts or PO adducts or EO/PO adducts with the respective hydroxyl-containing compound; in the case EO/PO adducts, the addition of EO and PO may take place statistically or blockwise.

In one embodiment, substances of the general structure) R⁸—O—R⁹—CH₂—CH(R¹⁰)—NH₂ are used as compounds (c). In this structural formula:
R⁸ is a monovalent organic group having 1-12 C atoms that may be aliphatic, cycloaliphatic or aromatic
R⁹ is a polyoxyalkylene group composed of 5-200 polyoxyalkylene units, especially EO and/or PO units,
R¹⁰ is hydrogen or an aliphatic radical having up to 4 C atoms.

Particularly suitable representatives of the compounds (c) in the context of the present invention are the “Jeffamines” known to the person skilled in the art, which are commercially available substances. An example that may be mentioned here is “Jeffamine 2070”, which according to Texaco is prepared by reaction of methanol with ethylene oxide and propylene oxide and also conversion of the terminal hydroxyl groups of the initial intermediate into amine groups (compare WO 96/20971, page 10, lines 12-15).

The compounds (c) preferably have average molecular weights (numerical average; Mn) in the range from 148 to 5000, more particularly between 400 and 2000.

The epoxide compounds (d) are polyepoxides having on average at least two epoxide groups per molecule. These epoxide compounds may be saturated or unsaturated and also aliphatic, cycloaliphatic, aromatic or heterocyclic, and may also contain hydroxyl groups. Additionally, they may contain substituents which under the conditions of mixing and of reaction do not give rise to any disruptive side-reactions, examples being alkyl or aryl constituents, ether moieties and the like. These epoxide compounds are preferably polyglycidyl ethers based on polyhydric, preferably dihydric, alcohols, phenols, hydrogenation products of these phenols, and/or on novolaks (reaction products of monohydric or polyhydric phenols with aldehydes, especially formaldehyde, in the presence of acidic catalysts). The epoxide equivalent weights of these epoxide compounds are preferably between 160 and 500, in particular between 170 and 250. The epoxide equivalent weight of a substance is defined as the amount of the substance (in grams) that contains 1 mol of oxirane rings.

Suitable polyhydric phenols are preferably the following compounds:

resorcinol, hydroquinone, 2,2-bis(4-hydroxyphenyl)propane (bisphenol A), isomer mixtures of dihydroxydiphenylmethane (bisphenol F), tetrabromobisphenol A, 4,4′-dihydroxy-diphenylcyclohexane, 4,4′-dihydroxy-3,3-dimethyldiphenyl-propane, 4,4′-dihydroxybiphenyl, 4,4′-dihydroxybenzophenol, 1,1-bis(4-hydroxyphenyl)ethane, 1,1-bis(4-hydroxy-phenyl)isobutane, bis(4-hydroxyphenyl)methane, bis(4-hydroxyphenyl)ether, bis(4-hydroxyphenyl)sulphone, etc., and also the chlorination and bromination products of the aforementioned compounds; bisphenol A is especially preferred.

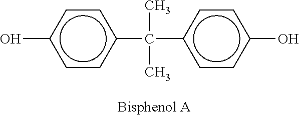

Also suitable as compounds (d) are the polyglycidyl ethers of polyhydric alcohols. Examples of such polyhydric alcohols include ethylene glycol, diethylene glycol, triethylene glycol, 1,2-propylene glycol, polyoxypropylene glycol (n=1-20), 1,3-propylene glycol, 1,4-butylene glycol, 1,5-pentanediol, 1,6-hexanediol, 1,2,6-hexanetriol, glycerol and 2,2-bis(4-hydroxycyclohexyl)propane.

It is also possible to use polyglycidyl ethers of polycarboxylic acids as compounds (d), which are obtained by the reaction of epichlorohydrin or similar epoxy compounds with an aliphatic, cycloaliphatic or aromatic polycarboxylic acid, such as oxalic acid, succinic acid, adipic acid, glutaric acid, phthalic acid, terephthalic acid, hexahydrophthalic acid, 2,6-naphthalenedicarboxylic acid and dimerized linolenic acid. Examples are diglycidyl adipate, diglycidyl phthalate and diglycidyl hexahydro-phthalate.

A comprehensive listing of suitable epoxide compounds (d) is found in:
A. M. Paquin, “Epoxidverbindungen und Epoxidharze” Handbook, Springer-Verlag, Berlin 1958, Chapter V, pages 308 to 461; and also in:
Lee, Neville “Handbook of Epoxy Resins”, 1967, Chapter 2, pages 2-1 to 2-33.

Mixtures of two or more epoxide compounds (d) can also be used.

Amines (e) employed in the context of the present invention are primary and/or secondary amines. As amines (e) it is preferred to use polyamines having at least two nitrogen atoms and at least two active amino hydrogen atoms per molecule. Aliphatic, aromatic, aliphatic-aromatic, cycloaliphatic and heterocyclic diamines and polyamines can be utilized.

Examples of suitable amines (e) are as follows: polyethyleneamines (ethylenediamine, diethylenetriamine, triethylenetetramine, tetraethylenepentamine, etc.), 1,2-propylenediamine; 1,3-propylenediamine, 1,4-butanediamine, 1,5-pentanediamine, 1,3-pentanediamine, 1,6-hexanediamine, 3,3,5-trimethyl-1,6-hexanediamine, 3,5,5-trimethyl-1,6-hexanediamine, 2-methyl-1,5-pentanediamine, bis(3-aminopropyl)amine, N,N′-bis(3-aminopropyl)-1,2-ethanediamine, N-(3-aminopropyl)-1,2-ethanediamine, 1,2-diaminocyclohexane, 1,3-diaminocyclohexane, 1,4-diaminocyclohexane, aminoethylpiperazines, the poly(alkylene oxide) diamines and triamines (such as, for example, Jeffamine D-230, Jeffamine D-400, Jeffamine D-2000, Jeffamine D-4000, Jeffamine T-403, Jeffamine EDR-148, Jeffamine EDR-192, Jeffamine C-346, Jeffamine ED-600, Jeffamine ED-900, Jeffamine ED-2001), metaxylylenediamine, phenylenediamine, 4,4′-diaminodiphenylmethane, toluenediamine, isophoronediamine, 3,3′-dimethyl-4,4′-diaminodicyclohexylmethane, 4,4′-diaminodicyclohexylmethane, 2,4′-diaminodicyclohexylmethane, the mixture of the methylene-bridged poly(cyclohexyl-aromatic) amines (also known as MBPCAA) and polyaminoamides.

Additionally suitable as compounds (e) are the reaction products from the reaction of the aforementioned amines with the above-described alpha,beta-unsaturated carboxylic esters (a), and also the reaction products of the reaction of the aforementioned amines with the above-described polyepoxide compounds (d).

Hardeners of type B2) are obtainable by reacting

a) one or more α,β-unsaturated carboxylic esters (I)

R²R³C═C(R⁴)COOR¹ (I)

in which the radical R¹ is an aromatic or aliphatic radical having up to 15 carbon atoms, the radicals R², R³ and R⁴ independently of one another are hydrogen, branched or unbranched, aliphatic or aromatic groups having in each case up to 20 carbon atoms, or a group —(CH₂)ₙ—COOR¹ in which R¹ is as defined above and n is a number in the range from 0 to 10, with
c) one or more mono-, di- or polyaminopolyalkylene oxide compounds, the compounds (a) and (c) being used in amounts such that the equivalents ratio of the reactive H atoms on the amino nitrogen atoms of (c) to the C═C double bond shown in the formula (I) and positioned α,β to the group COOR¹ in the carboxylic esters (a) being in the range from 10:1 to 1:10,
then reacting the intermediate Z4 obtained in this one with
d) one or more polyepoxides, the equivalents ratio of oxirane rings in polyepoxide (d) to reactive hydrogen atoms of the mono-, di- or polyaminopolyalkylene oxide compounds used as per (c) being adjusted to a value in the range from 100:1 to 1.5:1,
and subsequently reacting the intermediate Z5 obtained in this case with
e) one or more primary and/or secondary amines, the equivalents ratio of oxirane rings in intermediate Z5 to the reactive H atoms on the amino nitrogen atoms of (e) being adjusted to a value in the range from 1:1.5 to 1:20.

For the substances (a) and the substances (c) to (e), the comments made above—for hardeners of type B1)—otherwise apply.

Curing agents of type B3) are obtainable by reacting

a) one or more α,β-unsaturated carboxylic esters (I)

R²R³C═C(R⁴)COOR¹ (I)

in which the radical R¹ is an aromatic or aliphatic radical having up to 15 carbon atoms, the radicals R², R³ and R⁴ independently of one another are hydrogen, branched or unbranched, aliphatic or aromatic groups having in each case up to 20 carbon atoms, or a group —(CH₂)ₙ—COOR¹ in which R¹ is as defined above and n is a number in the range from 0 to 10, with
c) one or more mono-, di- or polyaminopolyalkylene oxide compounds, the compounds (a) and (c) being used in amounts such that the equivalents ratio of the reactive H atoms on the amino nitrogen atoms of (c) to the C═C double bond shown in the formula (I) and positioned α,β to the group COOR¹ in the carboxylic esters (a) being in the range from 10:1 to 1:10,
and then reacting the initial intermediate Z4 obtained with
g) one or more polyhydroxy compounds, the equivalents ratio of ester groups in intermediate compound Z4 to hydroxyl groups in polyhydroxy compound (g) being adjusted to a value in the range from 1:1.1 to 1:10, and subsequently reacting the resultant intermediate Z6 with
d) one or more polyepoxides, the equivalents ratio of oxirane rings in polyepoxide (d) to hydroxyl groups in intermediate Z6 being adjusted to a value in the range from 1.5:1 to 6:1,
and subsequently reacting the intermediate Z7 obtained in this case with
e) one or more primary and/or secondary amines, the equivalents ratio of oxirane rings in intermediate Z7 to the reactive H atoms on the amino nitrogen atoms of (e) being adjusted to a value in the range from 1:1.5 to 1:20.

For the substances (a) and the substances (c) to (e), the comments made above—for hardeners of type B1)—otherwise apply.

The polyhydroxy compounds (g) may be aliphatic or aromatic. In one embodiment the polyhydroxy compounds (g) are selected from the class of specific aliphatic diols, and particularly of the alkanediols—especially the dimer diols—polyether diols and polyester diols. For the alkanediols—including the dimer diols—and the polyether diols the comments made above—for hardeners of type B1) in respect of component (b)—apply. For the polyester diols the following applies: polyester diols for the purposes of the present invention are diols of the general structure HOCH2—R⁷—CH2OH in which the radical R⁷ is a hydrophobic hydrocarbon radical, which may be saturated or unsaturated, straight-chain or branched, and which may, if appropriate, also contain aromatic structural elements, and in which necessarily one or more CH2 units have been replaced in each case by a COO unit. For the preparation it is usual to react difunctional polyols with dicarboxylic acids or their anhydrides. Polyols frequently used are ethylene glycol, 1,2-propanediol, 1,4-butanediol, 1,6-hexanediol. Typical dicarboxylic acids are succinic acid, adipic acid, phthalic anhydride. Particular preference is given in this context to 1,6-hexanediol-adipic acid polyesters.

In one embodiment, component B) is used in an amount of 5% to 25% by weight.

### Component C)

Component C) of the coating compositions of the invention comprises fibres.

As the person skilled in the art is aware, the expression “fibres” is used as a collective term for elongated assemblies whose molecules (or crystallites) have the same orientation throughout the longitudinal molecular direction (or a straight line of the lattice). Fibres are either fibriform structures of limited length (unitary fibres or hairs) or virtually continuous fibres (filaments), either individually or in bundled form.

The following fibres or blends thereof possess especial suitability as component C): Twaron 1091 and Twaron 1094.

The fibres C) serve in particular to influence the properties of the coating compositions. As well as improving the chemical, thermal and mechanical properties of coatings, there is also a critical influence on the production properties as a result of fibres. The coating compositions of the invention, further, exhibit positive effects in terms of processing properties. The presence of fibres C) in the coating compositions has the effect, for example, that the fillers present in the compositions settle only slowly or not at all, particularly not in the course of curing.

The presence of fibres C) in the compositions of the invention considerably enhances the mechanical properties of the coating compositions by comparison with fibre-free products. The compositions of the invention contain the fibres C) in an amount of 0.1% to 10% by weight—based on the entirety of all of the components of the coating composition. They are preferably used in an amount of 0.1% to 5.0% by weight. The range from 0.1% to 2.5% by weight is particularly preferred here, since it leads to self-levelling coatings; coating compositions with this last-mentioned fraction of fibres produce coatings which are substantially more flexible and exhibit higher flexural, tensile and tear-propagation strengths than coating compositions without fibres. Without the addition of fibres, in contrast, fragile coatings without extension are obtained, whose mechanical properties, as a result, cannot be determined.

### Component D)

Component D) of the coating compositions of the invention comprises what are called open-time extenders, based on wax. Systems of this kind are known to the person skilled in the art (on the concept of waxes see, for example, U. Zorll, Ed., RÖMPP-Lexikon, Lacke and Druckfarben, p. 615, Georg Thieme Verlag, Stuttgart, N.Y., 1998). To extend the open time, to increase conformity and plasticity in the filling and insulating compounds, in fact, processing is carried out using waxes in the form of aqueous emulsions or in solid supply form on mineral carrier materials. The term “waxes” embraces not only the waxes in the narrower sense but also fatty alcohols.

R. Neumann, H.-G. Schulte, R. Höfer, Pulver, das Eigenschaften schafft [Powder that makes properties], Bautenschutz and Bausanierung, Vol. 3/1999, pp. 22-27, and also U. Nagorny, Extension of workability of synthetic resin plasters with additives based on fatty raw materials; ConChem-Journal, No. 1/1994, pp. 23-26, give an in-depth description of wax-based processing additives of this kind. Particularly suitable are powder-form varieties of wax-based open-time extenders, especially fatty alcohols having 16 to 72 C atoms per molecule that have been applied to a solid carrier. In this context reference may be made expressly to the disclosure content of WO 98/49114.

Particularly suitable wax-based open-time extenders are the products, sold commercially by Cognis Deutschland GmbH, Düsseldorf/DE, Loxanol™ 842 DP (aqueous dispersion) and Loxanol™ P (anhydrous, powder-form solid).

In one embodiment, component D) is used in an amount of 0.1% to 2.0% by weight, based on the entirety of all of the components of the coating composition.

### Component E)

Component E) of the coating compositions of the invention comprises rheology additives. Here it is possible to use all of the rheology additives that are relevantly known to the person skilled in the art, preferably phyllosilicates or poly(meth)acrylates or cellulose ethers or what are called associative thickeners, alone or in combination.

Preference is given to phyllosilicates in combination with hydrophobically modified polyetherurethanes (HEUR) or hydrophobically modified polyethers (HMPE). Hydrophobic modification here means that hydrophobic groups are present in the molecules of the stated classes of substance. Particularly preferred HEUR are the solvent-free HEUR described in G. Schulte, J. Schmitz, R. Höfer, Additive für wässrige Systeme and umweltfreundliche Lacke [Additives for aqueous systems and eco-friendly paints], Welt der Farben, 28-31 (12/1997), and the pseudoplastic HEUR that are described in DE-A-42 42 687.

In one embodiment, component E) is used in an amount of 0% or 0.1% to 3.0% by weight, based on the entirety of all of the components of the coating composition.

### Component F)

Component F) of the coating compositions of the invention comprises fillers. Examples thereof are, for instance, quartz sand, heavy spar, calcium carbonates, silicates, calcium sulphate, talc, kaolin, mica, feldspar, metal oxides, aluminium hydroxide, aluminium silicates, carbon black, graphite, barium sulphate and the like. The fillers are used in an amount in the range from 5.0% to 70.0% by weight, based on the entirety of all of the components of the coating composition.

### Component G)

Component G) of the coating compositions of the invention (water) is used in an amount of 0% or 0.1% to 12.0% by weight, preferably in an amount of 1.0% to 10.0% by weight.

### Component H)

As component H) of the coating compositions of the invention it is possible to use further processing assistants and/or additives that are known to the person skilled in the art. Examples thereof are pigments, cement, gravel, deaerating agents, defoamers, dispersing assistants, anti-settling agents, accelerators, free amines, flow control additives and conductivity improvers.

The invention further provides for the use of the above-described coating compositions as levelling and insulating compounds, more particularly in the construction sector. There use for floors is particularly preferred.

The epoxy resin-based floor coating compositions of the invention exhibit the following advantages, which denote an improvement in comparison to the prior art:
low thickening effect in comparison to conventional rheology additives with the structurally modified AEROSIL product AEROSIL R 8200
owing to the low thickening effect of AEROSIL R 8200, the floor-coating compositions can be formulated to be self-levelling
owing to the low thickening action of AEROSIL R 8200, higher degrees of filling are possible, of up to 25% by weight
owing to the higher possible degrees of filling of AEROSIL R 8200, the mechanical properties of the floor-coating compositions are improved
AEROSIL R 8200 exhibits a significantly shorter incorporation time in comparison to conventional fumed silicas
Furthermore, AEROSIL R 8200 exhibits good dispersibility

1. A coating composition comprising
A) 5.0% to 50.0% by weight of an epoxy resin comprising reaction products of bisphenol A and/or bisphenol F with epichlorohydrin,
B) 5.0% to 55.0% by weight of a water-dilutable epoxy resin hardener,
C) 0.1% to 10.0% by weight of a fibre,
D) 5.0% or less by weight of a wax-based open-time extender
E) 5.0% or less by weight of a rheology additive,
F) 5.0% to 70% by weight of a filler,
G) 20.0% or less by weight of water and
H) 70% or less by weight of a further additive and/or processing assistant,
wherein the sum of the percentages by weight of components A) to H) form 100% by weight of the coating composition, and the rheology additive or the filler is replaced by a fumed silica which has been hydrophobicized with HMDS (hexamethyldisilazane) and subsequently structurally modified by a ball mill.

2. The composition according to claim 1, wherein component A is an epoxy resin liquid at 20 deg C.

3. The composition according to claim 1, wherein component A is an epoxy resin liquid at 20 deg C. which is a reaction product of bisphenol A with epichlorohydrin.

4. The composition according to claim 1, wherein component A) is in an amount of 5% to 30% by weight.

5. The composition according to claim 1, wherein component B) is in an amount of 5% to 25% by weight.

6. The composition according to claim 1, wherein component C) is in an amount of 0.1% to 2.5% by weight.

7. The composition according to claim 1, wherein component D) is in an amount of 0.1% to 2.0% by weight.

8. The composition according to claim 1, wherein component E) is in an amount of 0.1% to 3.0% by weight.

9. The composition according to claim 1, wherein component G) is in an amount of 1.0% to 12.0% by weight.

10. (canceled)

11. A coating composition comprising
A) 5.0% to 50.0% by weight of an epoxy resin comprising reaction products of bisphenol A and/or bisphenol F with epichlorohydrin,
B) 5.0% to 55.0% by weight of a water-dilutable epoxy resin hardener,
C) 0.1% to 10.0% by weight of a fibre,
D) optionally 0.1% to 5.0% by weight of a wax-based open-time extender,
E) optionally 0.1 to 5.0% by weight of a rheology additive,
F) 5.0% to 70% by weight of a filler,
G) optionally 0.1% to 20.0% by weight of water and
H) 0% to 70% by weight of a further additive and/or processing assistant,
wherein the sum of the percentages by weight of components A) to H) form 100% by weight of the coating composition, and the rheology additive or the filler is replaced by a fumed silica which has been hydrophobicized with HMDS (hexamethyldisilazane) and subsequently structurally modified by a ball mill.

12. The composition according to claim 11, wherein component A is an epoxy resin liquid at 20 deg C.

13. The composition according to claim 11, wherein component A is an epoxy resin liquid at 20 deg C. which is a reaction product of bisphenol A with epichlorohydrin.

14. The composition according to claim 11, wherein component A) is in an amount of 5% to 30% by weight.

15. The composition according to claim 11, wherein component B) is in an amount of 5% to 25% by weight.

16. The composition according to claim 11, wherein component C) is in an amount of 0.1% to 2.5% by weight.

17. The composition according to claim 11, wherein component D) is in an amount of 0.1% to 5.0% by weight.

18. The composition according to claim 11, wherein component E) is in an amount of 0.1% to 5.0% by weight.

19. The composition according to claim 11, wherein component G) is in an amount of 1.0% to 20.0% by weight.

20. A leveling or insulating compound comprising the coating composition according to claim 1.

21. A leveling or insulating compound comprising the coating composition according to claim 11.
